(19) United States
(12) Patent Application Publication
(10) Pub. No.: US 2022/0367131 A1
(43) Pub. Date: Nov. 17, 2022

(54) LIGHT GUIDE PLATE AND BACKLIGHT MODULE OF ILLUMINATED KEYBOARD

(71) Applicant: Chicony Power Technology Co., Ltd., New Taipei City (TW)

(72) Inventors: Cheng-Yuan Cheng, New Taipei City (TW); Hsuan-Wei Ho, New Taipei City (TW)

(21) Appl. No.: 17/406,716

(22) Filed: Aug. 19, 2021

(30) Foreign Application Priority Data
May 13, 2021 (TW) 110117380

(51) Int. Cl. H01H 13/83; G06F 3/02; F21V 8/00

(52) U.S. Cl. CPC H01H 13/83; G06F 3/0202; G02B 6/004

(57) ABSTRACT

A light guide plate and a backlight module adapted to an illuminated keyboard are provided. The light guide plate includes a single-key light guide region. The single-key light guide region corresponds to a single key. Four diagonal regions of the single-key light guide region has a plurality of microstructures. The area sum of the plurality of microstructures is smaller than the area sum of the four diagonal regions of the single-key light guide region. Through the area control of a plurality of microstructures, the plurality of microstructures of a plurality of keys guide the light to make the brightness of each of the keys is even.

### CROSS-REFERENCE TO RELATED APPLICATION

This non-provisional application claims priority under 35 U.S.C. § 119(a) to Patent Application No. 110117380 filed in Taiwan, R.O.C. on May 13, 2021, the entire contents of which are hereby incorporated by reference.

### BACKGROUND

### Technical Field

The present disclosure relates to a light guide plate and a backlight module, and particularly relates to a light guide plate and a backlight module of an illuminated keyboard.

### Related Art

A keyboard is a common input device for electronic apparatuses, such as computers, notebook computers, tablet computers and mobile phones. The computers and the notebook computers are usually equipped with physical keyboards, and the tablet computers and the mobile phones may be equipped with virtual keyboards.

When a user uses a physical keyboard, he/she sometimes needs to rely on light illuminating keys to identify and press correct keys. Some keyboard uses a single light source to illuminate several keys. The light from the single light sources is guided to illuminate each of the keys. However, the amount of the light guided to one of the keys is usually different from the other. This causes uneven brightness of each of the keys.

### SUMMARY

In view of the above, the present disclosure provides a light guide plate and a backlight module of an illuminated keyboard, which may enable the brightness of each of the keys on the keyboard to be even when being used.

According to some embodiments, a light guide plate of an illuminated keyboard includes a single-key light guide region. The single-key light guide region includes a first sub-light guide region, a third sub-light guide region, a seventh sub-light guide region and a ninth sub-light guide region located in four diagonal regions respectively, a fifth sub-light guide region located in a middle region, and a second sub-light guide region, a fourth sub-light guide region, a sixth sub-light guide region and an eighth sub-light guide region adjacent to the fifth sub-light guide region respectively. The sum of the light-emitting areas of a plurality of microstructures disposed in the first sub-light guide region is a first light-emitting total area. The sum of the light-emitting areas of a plurality of microstructures disposed in the third sub-light guide region is a third light-emitting total area. The sum of the light-emitting areas of a plurality of microstructures disposed in the seventh sub-light guide region is a seventh light-emitting total area. The sum of the light-emitting areas of a plurality of microstructures disposed in the ninth sub-light guide region is a ninth light-emitting total area. The area sum of the first light-emitting total area, the third light-emitting total area, the seventh light-emitting total area and the ninth light-emitting total area is smaller than the area sum of the first sub-light guide region, the third sub-light guide region, the seventh sub-light guide region and the ninth sub-light guide region.

According to some embodiments, the sum of the light-emitting areas of a plurality of microstructures disposed in the fifth sub-light guide region is a fifth light-emitting total area. The first light-emitting total area, the third light-emitting total area, the seventh light-emitting total area or the ninth light-emitting total area is greater than the fifth light-emitting total area.

According to some embodiments, the sum of the light-emitting areas of a plurality of microstructures disposed in the second sub-light guide region is a second light-emitting total area. The sum of the light-emitting areas of a plurality of microstructures disposed in the fourth sub-light guide region is a fourth light-emitting total area. The sum of the light-emitting areas of a plurality of microstructures disposed in the sixth sub-light guide region is a sixth light-emitting total area. The sum of the light-emitting areas of a plurality of microstructures disposed in the eighth sub-light guide region is an eighth light-emitting total area. The area sum of the second light-emitting total area, the fourth light-emitting total area, the sixth light-emitting total area and the eighth light-emitting total area is smaller than the area sum of the first light-emitting total area, the third light-emitting total area, the seventh light-emitting total area and the ninth light-emitting total area.

According to some embodiments, the area sum of the first light-emitting total area, the second light-emitting total area and the third light-emitting total area is greater than the area sum of the first light-emitting total area, the fourth light-emitting total area and the seventh light-emitting total area.

According to some embodiments, a plurality of microstructures in the first sub-light guide region, the second sub-light guide region, the third sub-light guide region, the sixth sub-light guide region, the ninth sub-light guide region, the eighth sub-light guide region, the seventh sub-light guide region and the fourth sub-light guide region together form a loop shape.

According to some embodiments, a backlight module of an illuminated keyboard includes a circuit board, an illuminated component and a light guide plate. The illuminated component is located on the circuit board. The light guide plate is disposed above the circuit board. The light guide plate includes a first single-key light guide region and a second single-key light guide region. The first single-key light guide region includes a first first-sub-light guide region, a first third-sub-light guide region, a first seventh-sub-light guide region and a first ninth-sub-light guide region located in four diagonal regions respectively, a first fifth-sub-light guide region located in a middle region, and a first second-sub-light guide region, a first fourth-sub-light guide region, a first sixth-sub-light guide region and a first eighth-sub-light guide region adjacent to the first fifth-sub-light guide region respectively. The second single-key light guide region includes a second first-sub-light guide region, a second third-sub-light guide region, a second seventh-sub-light guide region and a second ninth-sub-light guide region located in four diagonal regions respectively, a second fifth-sub-light guide region located in a middle region, and a second second-sub-light guide region, a second fourth-sub-light guide region, a second sixth-sub-light guide region and a second eighth-sub-light guide region adjacent to the second fifth-sub-light guide region respectively. The first first-sub-light guide region, the first third-sub-light guide region, the first seventh-sub-light guide region, the first ninth-sub-light guide region, the second first-sub-light guide region, the second third-sub-light guide region, the second seventh-sub-light guide region and the second ninth-sub-light guide region respectively have a first first-light-emitting total area, a first third-light-emitting total area, a first seventh-light-emitting total area, a first ninth-light-emitting total area, a second first-light-emitting total area, a second third-light-emitting total area, a second seventh-light-emitting total area and a second ninth-light-emitting total area obtained by totaling the light-emitting areas of a plurality of microstructures disposed in each of the sub-light guide regions. The area sum of the first first-light-emitting total area, the first third-light-emitting total area, the first seventh-light-emitting total area and the first ninth-light-emitting total area is smaller than the area sum of the first first-sub-light guide region, the first third-sub-light guide region, the first seventh-sub-light guide region and the first ninth-sub-light guide region. The area sum of the second first-light-emitting total area, the second third-light-emitting total area, the second seventh-light-emitting total area and the second ninth-light-emitting total area is smaller than the area sum of the second first-sub-light guide region, the second third-sub-light guide region, the second seventh-sub-light guide region and the second ninth-sub-light guide region.

According to some embodiments, the first single-key light guide region has a first center corresponds to the center of a first key cap above. The second single-key light guide region has a second center corresponds to the center of a second key cap above. When a first distance between the first center and the center of the illuminated component is smaller than a second distance between the second center and the center of the illuminated component, the area sum of the first first-light-emitting total area, the first third-light-emitting total area, the first seventh-light-emitting total area and the first ninth-light-emitting total area is smaller than the area sum of the second first-light-emitting total area, the second third-light-emitting total area, the second seventh-light-emitting total area and the second ninth-light-emitting total area.

According to some embodiments, when the area of the first single-key light guide region is smaller than twice the area of the second single-key light guide region, the sum of the light-emitting areas of a plurality of microstructures in the first second-sub-light guide region, the first fourth-sub-light guide region, the first sixth-sub-light guide region and the first eighth-sub-light guide region is smaller than the sum of the light-emitting areas of a plurality of microstructures in the second second-sub-light guide region, the second fourth-sub-light guide region, the second sixth-sub-light guide region and the second eighth-sub-light guide region.

According to some embodiments, a light guide plate of an illuminated keyboard includes a single-key light guide region. The single-key light guide region has a light guide optical pattern. The light guide optical pattern includes a linear segment, a curve segment, an arc segment or a combination thereof. The light-emitting area of the light guide optical pattern is smaller than the area of the single-key light guide region.

According to some embodiments, the linear segment, the curve segment or the arc segment has a first microstructure unit, a second microstructure unit and a third microstructure unit. The first microstructure unit and the second microstructure unit have different shapes, or the first microstructure unit and the third microstructure unit have different areas, or the second microstructure unit and the third microstructure unit are connected or overlapped, or there is a distance between the first microstructure unit and the third microstructure unit.

In conclusion, according to some embodiments, through the control of the light-emitting areas of a plurality of microstructures in the single-key light guide region of the light guide plate, the sum of the light-emitting areas of a plurality of microstructures in the four diagonal regions is smaller than the area sum of the four diagonal regions, and after a plurality of microstructures of each of the keys guide the light, the brightness of each of the keys is even for a user to view, thereby avoiding the condition that the brightness of each of the keys is obviously uneven.

### BRIEF DESCRIPTION OF THE DRAWINGS

FIG. 1 shows a three-dimensional schematic exploded view of an illuminated keyboard according to some embodiments;

FIG. 2 shows a partial schematic cross-sectional view of an illuminated keyboard according to some embodiments;

FIG. 3 shows a schematic top view of a single key cap perspective to a backlight module according to some embodiments;

FIG. 4 shows a schematic top view (I) of a single-key light guide region of a light guide plate according to some embodiments in a viewing angle of FIG. 3;

FIG. 5 shows a schematic top view (II) of the single-key light guide region of the light guide plate according to some embodiments in a viewing angle of FIG. 3;

FIG. 6 shows a schematic top view (III) of the single-key light guide region of the light guide plate according to some embodiments in a viewing angle of FIG. 3;

FIG. 7 shows a schematic top view (IV) of the single-key light guide region of the light guide plate according to some embodiments in a viewing angle of FIG. 3;

FIG. 8 shows a schematic top view (V) of the single-key light guide region of the light guide plate according to some embodiments in a viewing angle of FIG. 3;

FIG. 9 shows a schematic top view (VI) of the single-key light guide region of the light guide plate according to some embodiments in a viewing angle of FIG. 3;

FIG. 10 shows a schematic top view (I) of a backlight module corresponding to two key caps according to some embodiments in a viewing angle of FIG. 3;

FIG. 11 shows a schematic top view (II) of the backlight module corresponding to two key caps according to some embodiments in a viewing angle of FIG. 3;

FIG. 12 shows a schematic view (I) of shapes of a plurality of different types of microstructures according to some embodiments;

FIG. 13 shows a schematic view (II) of shapes of a plurality of different types of microstructures according to some embodiments; and

FIG. 14 shows a schematic view of shapes and arrangement of a plurality of microstructure units according to some embodiments.

### DETAILED DESCRIPTION

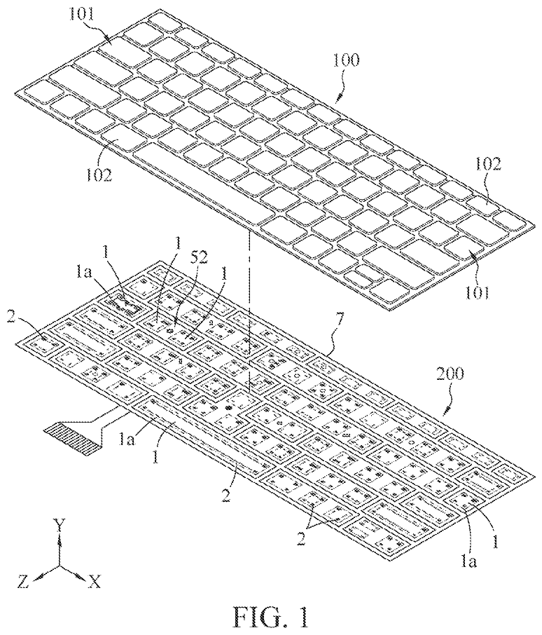

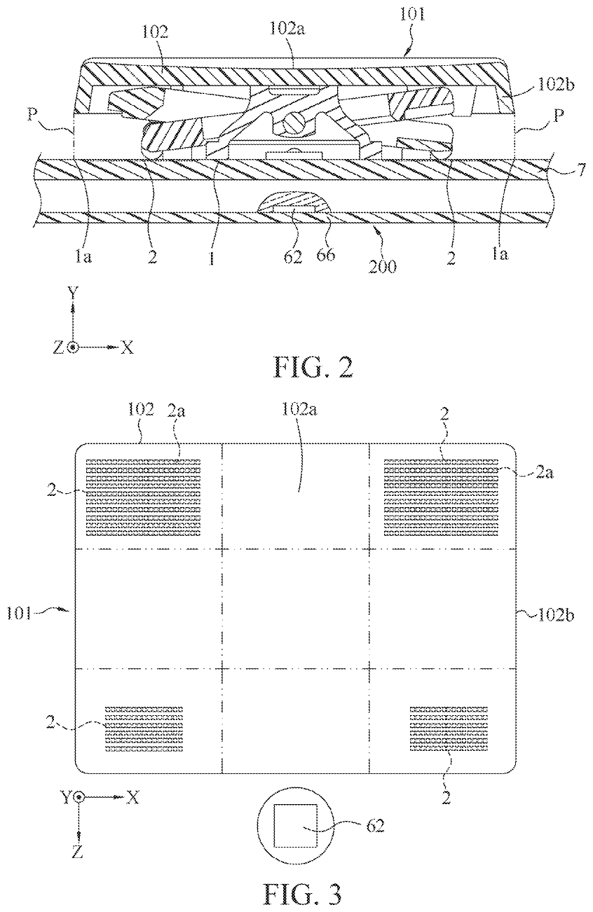

Referring to FIG. 1, FIG. 2 and FIG. 3 at the same time, key caps 102 have symbol notes (or called characters not shown in the figures). The symbol notes may be any symbols required by keyboard functions, such as but not limited to English words, numbers or special symbols. The key caps 102 may be made of semi-transparent materials, or the symbol notes (or called characters) of the key caps 102 adopt a semi-transparent design, therefore, the light passing through the top surface of a light guide plate 7 may lighten the symbol notes for a user to view. When an illuminated component 62 is driven, the light emitted by the illuminated component 62 enters the light guide plate 7 for total reflection and propagation. When the light entering the light guide plate 7 travels to microstructures 2 (or called mesh point parts or light spot parts), the light is guided by the microstructures 2 toward the key caps 102, and finally, the light is emitted fully or partially from surfaces 102a of the key caps 102 and from the lower peripheral edges of frames 102b. In this way, the characters on the surfaces 102a of the key caps 102 are bright and easy to recognize, and the light is emitted from the lower peripheral edges of the frames 102b to form haloes around the key caps 102, so that users can more easily recognize and distinguish individual key caps 102. As mentioned above, the microstructures 2 are configured to guide the light entering the light guide plate 7 toward the key caps 102. Therefore, if the microstructures 2 are fully distributed in a single-key light guide region 1, the light will be fully guided and emitted. After the light is fully guided and emitted, in addition to the too high brightness of a first key 101 closest to the illuminated component 62, the light of a second key 101 (the second key 101 is located around the first key 101) at the rear on the original light path will be reduced, so that the brightness of the second key 101 is obviously too dark, and the brightness of each of the keys 101 on a keyboard 100 is obviously uneven. FIG. 1 shows a three-dimensional schematic exploded view of an illuminated keyboard 100, wherein a backlight module 200 of the illuminated keyboard 100 is shown. FIG. 2 shows a partial schematic cross-sectional view of the illuminated keyboard 100, wherein the backlight module 200 includes an illuminated component 62, a circuit board 66 and a light guide plate 7 (detailed later). FIG. 3 shows a schematic top view of a single key cap 102 perspective to the backlight module 200, wherein dotted lines represent a perspective state, two-dot chain lines are custom virtual lines, and relative positions of a plurality of microstructures 2 and the illuminated component 62 are shown.

According to some embodiments, a light guide plate 7 of an illuminated keyboard 100 includes a single-key light guide region 1. The single-key light guide region 1 is located on the light guide plate 7. The single-key light guide region 1 corresponds to only one key 101. Nine regions are defined on the single-key light guide region 1 (as shown in FIG. 3, the nine regions are divided by two-dot chain lines (virtual lines), and actual products do not have the virtual lines). Referring to FIG. 4, FIG. 4 shows a schematic top view of a single-key light guide region 1 of a light guide plate 7, wherein four diagonal regions of the single-key light guide region 1 have microstructures 2. In some embodiments, the single-key light guide region 1 includes a first sub-light guide region 11, a third sub-light guide region 13, a seventh sub-light guide region 17 and a ninth sub-light guide region 19 located in four diagonal regions respectively, a fifth sub-light guide region 15 located in a middle region, and a second sub-light guide region 12, a fourth sub-light guide region 14, a sixth sub-light guide region 16 and an eighth sub-light guide region 18 adjacent to the fifth sub-light guide region 15 respectively. In order to solve the problem that when the microstructures 2 are fully distributed in the single-key light guide region 1, the light will be fully guided and emitted, the brightness of the first key 101 closest to the illuminated component 62 is too high, the brightness of the second key 101 (the second key 101 is located around the first key 101) at the rear on the original light path is too dark, and thus the brightness of each of the keys 101 on the keyboard 100 is obviously uneven, the microstructures 2 are respectively distributed in the first sub-light guide region 11, the third sub-light guide region 13, the seventh sub-light guide region 17 and the ninth sub-light guide region 19, each of the microstructures 2 has a light-emitting area 2a, the sum of the light-emitting areas 2a of a plurality of microstructures 2 disposed in the first sub-light guide region 11 is a first light-emitting total area, the sum of the light-emitting areas 2a of a plurality of microstructures 2 disposed in the third sub-light guide region 13 is a third light-emitting total area, the sum of the light-emitting areas 2a of a plurality of microstructures 2 disposed in the seventh sub-light guide region 17 is a seventh light-emitting total area, and the sum of the light-emitting areas 2a of a plurality of microstructures 2 disposed in the ninth sub-light guide region 19 is a ninth light-emitting total area. The area sum of the first light-emitting total area, the third light-emitting total area, the seventh light-emitting total area and the ninth light-emitting total area is smaller than the area sum of the first sub-light guide region 11, the third sub-light guide region 13, the seventh sub-light guide region 17 and the ninth sub-light guide region 19.

Since the microstructures 2 are distributed in the four diagonal regions, namely the first sub-light guide region 11, the third sub-light guide region 13, the seventh sub-light guide region 17 and the ninth sub-light guide region 19, the light can be transmitted to other single-key light guide regions 1 through the fifth sub-light guide region 15 (as shown in FIG. 3), the second sub-light guide region 12, the fourth sub-light guide region 14, the sixth sub-light guide region 16 and the eighth sub-light guide region 18 with no microstructures 2 distributed and regions between single-key light guide regions 1, so as to solve the problem that the brightness of each of the keys 101 on the keyboard 100 is obviously uneven.

Referring to FIG. 2 and FIG. 3, in some embodiments, the single-key light guide region 1 corresponds to one key 101. Peripheral edges 1a of the single-key light guide region 1 are opposite to plumb lines P at the outer edges of the frame 102b of a key cap 102. The plumb lines P (aligned lines of two-dot chain lines as shown in FIG. 2) and the Y axis are in the same direction. The peripheral edges 1a of the single-key light guide region 1 are vertical mappings of the outer edges of the frame 102b of the key cap 102.

Referring to FIG. 4, the figure shows a schematic top view of a single-key light guide region 1 of a light guide plate 7, wherein four diagonal regions of the single-key light guide region 1 have microstructures 2. In some embodiments, the locations of the first sub-light guide region 11, the third sub-light guide region 13, the seventh sub-light guide region 17 and the ninth sub-light guide region 19 are as follows: the first sub-light guide region 11 is located at the upper left corner, the third sub-light guide region 13 is located at the upper right corner, the seventh sub-light guide region 17 is located at the lower left corner, and the ninth sub-light guide region 19 is located at the lower right corner (not limited to this).

Referring to FIG. 4, in some embodiments, the second sub-light guide region 12 is located between the first sub-light guide region 11 and the third sub-light guide region 13, the fourth sub-light guide region 14 is located between the first sub-light guide region 11 and the seventh sub-light guide region 17, the sixth sub-light guide region 16 is located between the third sub-light guide region 13 and the ninth sub-light guide region 19, and the eighth sub-light guide region 18 is located between the seventh sub-light guide region 17 and the ninth sub-light guide region 19 (not limited to this).

In some embodiments, each of the first sub-light guide region 11 to the ninth sub-light guide region 19 may be of a square, a rectangle, a circle, a trapezoid, a triangle or other shapes, and the shape of each of the sub-light guide regions is not limited.

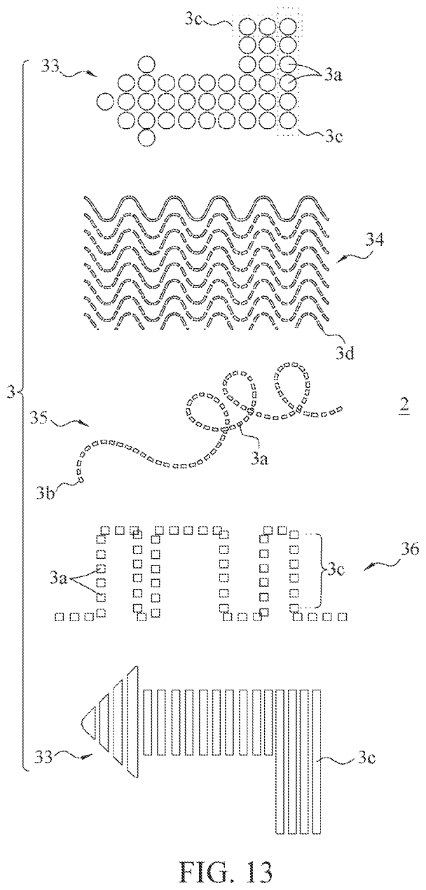

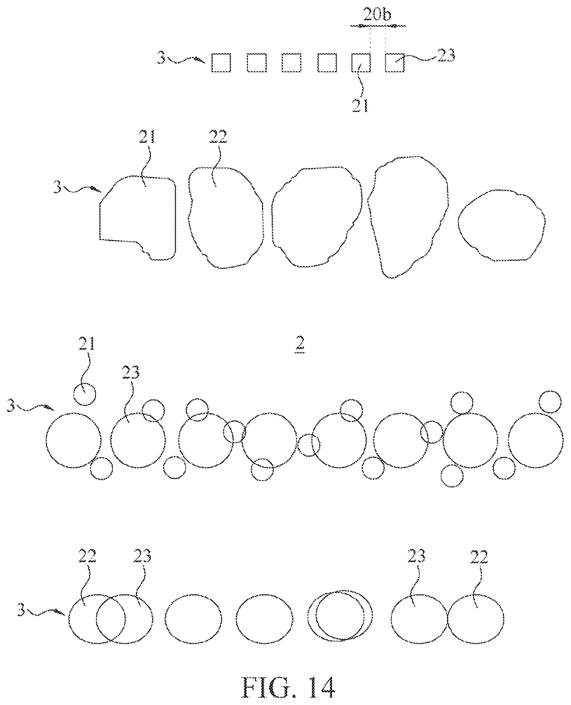

Referring to FIG. 2 and FIG. 3, the microstructures 2 have light-emitting areas 2a on the surface of the light guide plate 7, the above-mentioned light-emitting total area (such as the first light-emitting total area, the third light-emitting total area, the seventh light-emitting total area or the ninth light-emitting total area) refers to the area obtained by totaling the light-emitting areas 2a of the microstructures 2 in an individual sub-light guide region, and the light-emitting total area does not include the area of the sub-light guide region with no microstructures 2 disposed (as shown in FIG. 4, FIG. 12 and FIG. 13) and the distance 20b between the microstructures 2 (as shown in FIG. 4 and FIG. 14). Therefore, the area of the single-key light guide region 1 is greater than the area sum of the light-emitting areas 2a of all microstructures 2 disposed in the single-key light guide region 1, that is, the microstructures 2 in the single-key light guide region 1 will not be fully distributed in the whole single-key light guide region 1 without gaps, and then, part of the light can be transmitted to other single-key light guide regions 1 and emitted.

Referring to FIG. 2, in some embodiments, the microstructures 2 may be convex points, concave points, mesh points or light spots formed by ink jet (such as printing ink), laser or imprinting, and are distributed in a high density pattern. The microstructures 2 may be protruded or recessed on the surface of the light guide plate 7. In some other embodiments, the cross sections of individual units of the microstructures 2 are semi-circular convex points or concave points (not limited to this), and may be of any shapes, such as irregular shapes, cones, squares, triangles or trapezoids.

In some embodiments, the backlight module 200 may be selected from a side light-incident backlight module or a direct type backlight module according to needs. The illuminated component 62 in the backlight module 200 may be selected from one or a combination of a Light-Emitting Diode (LED), a Mini Light-Emitting Diode (Mini LED), a Micro Light-Emitting Diode (Micro LED) and an Organic Light-Emitting Diode (OLED) according to needs.

Referring to FIG. 4, in some embodiments, when the first sub-light guide region 11 and the third sub-light guide region 13 are light guide regions far away from a user and the seventh sub-light guide region 17 and the ninth sub-light guide region 19 are light guide regions close to the user, the sum of the first light-emitting total area and the third light-emitting total area is greater than the sum of the seventh light-emitting total area and the ninth light-emitting total area, thereby increasing the brightness of the light guide regions far away from the user and reducing the brightness of the light guide regions close to the user, so as to avoid the visual difference in brightness due to the distance or angle from the eyes to the keys even though the brightness is the same to achieve the visual effect of even light on the keys.

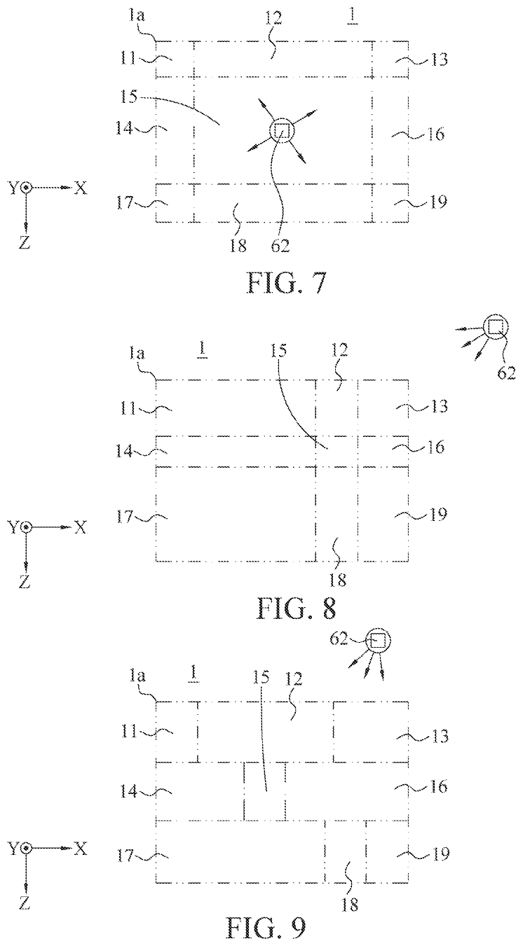

Referring to FIG. 7 to FIG. 9, FIG. 7 to FIG. 9 show schematic top views of the single-key light guide region 1 divided into nine sub-light guide regions, two-dot chain lines in FIG. 7 to FIG. 9 are virtual lines, and actual products do not have such lines. Based on different factors such as the relative position, angle and distance of the single-key light guide region 1 and the illuminated component 62, in order to enable the illuminated keyboard 100 and respective keys 101 to have a good even light effect, in some embodiments, the area of each of the first sub-light guide region 11 to the ninth sub-light guide region 19 may be the same (the area of each of the regions as shown in FIG. 4 is the same) or different (the area of each of the regions as shown in FIG. 7 to FIG. 9 may be the same or different, the areas of the first sub-light guide region 11, the third sub-light guide region 13, the seventh sub-light guide region 17 and the ninth sub-light guide region 19 of the single-key light guide region 1 as shown in FIG. 7 are the same and are smaller than the areas of other regions, the area of the fifth sub-light guide region 15 of the single-key light guide region 1 as shown in FIG. 8 is smaller than the areas of other regions, the fifth sub-light guide region 15 is arranged close to the right side, and the areas of the nine light guide regions of the single-key light guide region 1 as shown in FIG. 9 are all different), and the numbers of the sub-light guide regions (such as the first sub-light guide region 11, the second sub-light guide region 12 to the ninth sub-light guide region 19) in each of the embodiments are only used for illustrative description, and are not limited to the positions in icon examples.

In some embodiments, when the illuminated component 62 is disposed in the position below the center of the key 101, the illuminated component 62 directly emits light to the key 101 from the center position, and the brightness of the remaining regions is approximately equal except for the four diagonal regions which are slightly darker, therefore, the first sub-light guide region 11, the third sub-light guide region 13, the seventh sub-light guide region 17 and the ninth sub-light guide region 19 as shown in FIG. 7 only need a small region area to distribute the microstructures 2 to supplement the light, and then, the brightness of the key 101 may be even. In some other embodiments, when the illuminated component 62 is disposed at the upper right position of the key 101, the seventh sub-light guide region 17 as shown in FIG. 8 is far from the illuminated component 62, therefore, a large region area is needed to distribute the microstructures 2 to supplement the light, and then, the brightness of the key 101 may be even. In some other embodiments, when the key 101 is located at the lower left position of the illuminated keyboard 100 and the illuminated component 62 is located at the upper position close to the right of the key 101, the seventh sub-light guide region 17 as shown in FIG. 9 is located in a visual deviation region of a user, and part of the light is guided by the microstructures in the first sub-light guide region 11 and emitted, therefore, the seventh sub-light guide region 17 is designed to have a large region area to distribute the microstructures 2 to increase the brightness, and furthermore, the second sub-light guide region 12 is designed to have a large region area to increase the light transmitted to the seventh sub-light guide region 17 and the ninth sub-light guide region 19.

Referring to FIG. 2 to FIG. 4, in some embodiments, the light-emitting areas 2a of a plurality of microstructures 2 in the first sub-light guide region 11, the third sub-light guide region 13, the seventh sub-light guide region 17 and the ninth sub-light guide region 19 may enable the emitted light to cover the surface 102a and the frame 102b of the key 101. However, since only part of the light guided by a plurality of microstructures 2 in the first sub-light guide region 11, the third sub-light guide region 13, the seventh sub-light guide region 17 and the ninth sub-light guide region 19 is emitted toward the center position of the surface 102a of the key 101, in order to solve the uneven brightness problem that the surface 102a of the key 101 is dark in center and bright in periphery, a plurality of microstructures 2 are disposed in the fifth sub-light guide region 15 so as to make up for the emitted light at the center position of the surface 102a of the key 101. Since a plurality of microstructures 2 in the fifth sub-light guide region 15 are only designed to make up for the emitted light, when the sum of the light-emitting areas 2a of a plurality of microstructures 2 in the fifth sub-light guide region 15 is a fifth light-emitting total area, the fifth light-emitting total area is smaller than the first light-emitting total area, the third light-emitting total area, the seventh light-emitting total area or the ninth light-emitting total area.

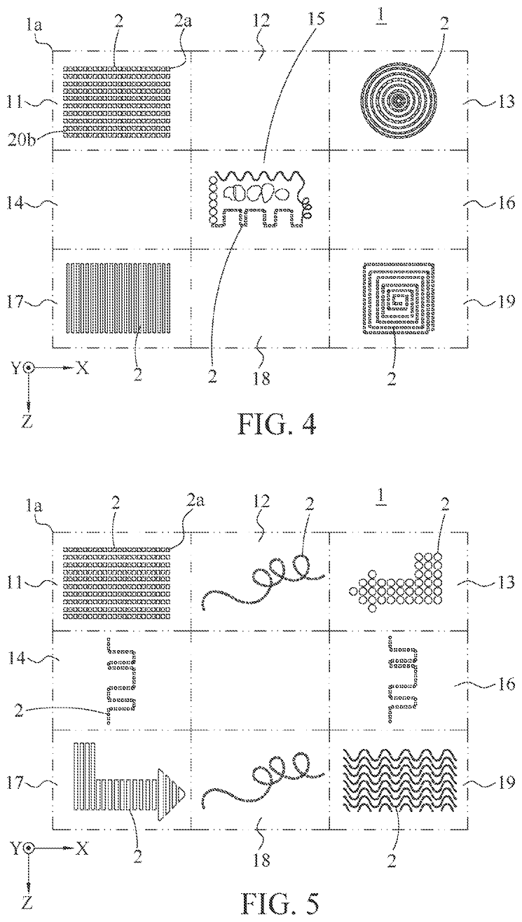

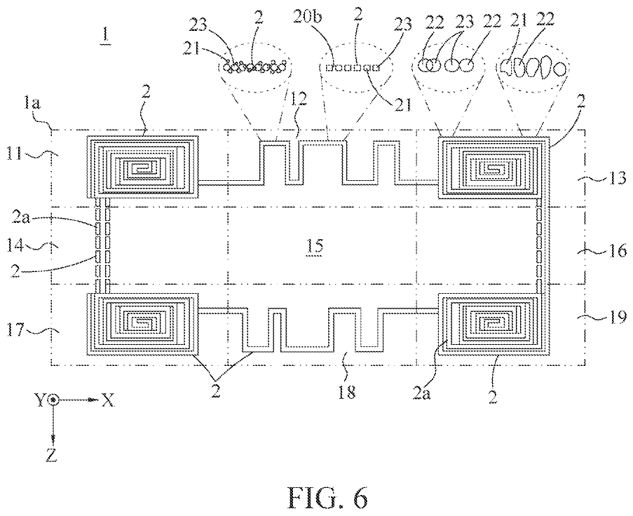

Referring to FIG. 5 and FIG. 6, FIG. 5 shows a schematic top view of a single-key light guide region 1 of a light guide plate 7, wherein four diagonal regions of the single-key light guide region 1 and regions between the four diagonal regions have microstructures 2, and there are gaps between the microstructures 2 (not connected) in each of the regions. In FIG. 6, four diagonal regions of a single-key light guide region 1 and regions between the four diagonal regions have microstructures 2, there are no gaps between the microstructures 2 (connected) in each of the regions, and partially enlarged views of a plurality of microstructures 2 are shown. In some embodiments, in order to solve the uneven brightness problem that the surface 102a of the key 101 is dark in center and bright in periphery, a plurality of microstructures 2 are distributed in one or two or three or four of the second sub-light guide region 12, the fourth sub-light guide region 14, the sixth sub-light guide region 16 and the eighth sub-light guide region 18. Since the second sub-light guide region 12, the fourth sub-light guide region 14, the sixth sub-light guide region 16 or the eighth sub-light guide region 18 is adjacent to the fifth sub-light guide region 15 below the center position of the surface 102a of the key 101, a plurality of microstructures 2 in the second sub-light guide region 12, the fourth sub-light guide region 14, the sixth sub-light guide region 16 or the eighth sub-light guide region 18 may guide part of the light to the center position of the surface 102a of the key 101 to be emitted, so as to make up for the lack of the light emitted by a plurality of microstructures 2 in the first sub-light guide region 11, the third sub-light guide region 13, the seventh sub-light guide region 17 and the ninth sub-light guide region 19 to the center position of the surface 102a of the key 101, and also make up for the lack of the light emitted from the peripheral regions between every two of the first sub-light guide region 11, the third sub-light guide region 13, the seventh sub-light guide region 17 and the ninth sub-light guide region 19.

Based on the above, since a plurality of microstructures 2 in the second sub-light guide region 12, the fourth sub-light guide region 14, the sixth sub-light guide region 16 or the eighth sub-light guide region 18 are used to make up for the emitted light, when the sum of the light-emitting areas 2a of a plurality of microstructures 2 in the second sub-light guide region 12 is a second light-emitting total area, the sum of the light-emitting areas 2a of a plurality of microstructures 2 in the fourth sub-light guide region 14 is a fourth light-emitting total area, the sum of the light-emitting areas 2a of a plurality of microstructures 2 in the sixth sub-light guide region 16 is a sixth light-emitting total area, and the sum of the light-emitting areas 2a of a plurality of microstructures 2 in the eighth sub-light guide region 18 is an eighth light-emitting total area, the first light-emitting total area, the third light-emitting total area, the seventh light-emitting total area or the ninth light-emitting total area is greater than the second light-emitting total area, the fourth light-emitting total area, the sixth light-emitting total area or the eighth light-emitting total area, or the sum of the first light-emitting total area, the third light-emitting total area, the seventh light-emitting total area and the ninth light-emitting total area is greater than the sum of the second light-emitting total area, the fourth light-emitting total area, the sixth light-emitting total area and the eighth light-emitting total area.

Referring to FIG. 6, in some embodiments, a key 101 is a long-multiple key (such as Shift key, Space key or Enter key), and the long-multiple key has two opposite long edges of a horizontal axis and two opposite short edges of a vertical axis. Therefore, when the single-key light guide region 1 corresponds to a long-multiple key 101, the long edges of the key 101 may be bright in two ends and dark in the middle. Especially, when the length of the long edges of the long-multiple key is 2 times or more than 2 times the length of the short edges, the problem that the long edges are bright in two ends and dark in the middle is more serious. Referring to FIG. 1 and FIG. 6, when the first sub-light guide region 11, the second sub-light guide region 12 and the third sub-light guide region 13 as well as the seventh sub-light guide region 17, the eighth sub-light guide region 18 and the ninth sub-light guide region 19 are respectively located on two long edges in the single-key light guide region 1 corresponding to the key 101, and the first sub-light guide region 11, the fourth sub-light guide region 14 and the seventh sub-light guide region 17 as well as the third sub-light guide region 13, the sixth sub-light guide region 16 and the ninth sub-light guide region 19 are respectively located on two short edges in the single-key light guide region 1 corresponding to the key 101, in order to solve the uneven brightness problem that the long edges of the key 101 may be bright in two ends and dark in the middle, the second sub-light guide region 12 and/or the eighth sub-light guide region 18 may be distributed with a plurality of microstructures 2. Compared with the long edges, the short edges of the key 101 have no uneven brightness problem that the two ends are bright and the middle is dark, therefore, the fourth sub-light guide region 14 and/or the sixth sub-light guide region 16 may be distributed with fewer microstructures 2 than the second sub-light guide region 12 or the eighth sub-light guide region 18, or may not be distributed with microstructures 2. By distributing a plurality of microstructures 2 in the second sub-light guide region 12 or the eighth sub-light guide region 18, the uneven brightness problem that the long edges of the key 101 may be bright in two ends and dark in the middle is solved, and furthermore, the brightness of the middle region of the surface 102a of the key 101 may also be increased.

Therefore, based on the above design, in the single-key light guide region 1, the area sum of the first light-emitting total area, the second light-emitting total area and the third light-emitting total area or the area sum of the seventh light-emitting total area, the eighth light-emitting total area and the ninth light-emitting total area is greater than the area sum of the first light-emitting total area, the fourth light-emitting total area and the seventh light-emitting total area or the area sum of the third light-emitting total area, the sixth light-emitting total area and the ninth light-emitting total area, that is, the sum of the light-emitting total areas of the microstructures 2 located on the long edges of the key 101 is greater than the sum of the light-emitting total areas of the microstructures 2 located on the short edges of the key 101. In some embodiments, when the first sub-light guide region 11, the second sub-light guide region 12, the third sub-light guide region 13, the fourth sub-light guide region 14, the sixth sub-light guide region 16, the seventh sub-light guide region 17, the eighth sub-light guide region 18 and the ninth sub-light guide region 19 are all distributed with microstructures 2, all the microstructures 2 in the single-key light guide region 1 form a loop shape (such as a single-port open loop, a multi-port open loop or a closed loop). The loop distribution of the microstructures 2 enables the key 101 to have a good even light effect.

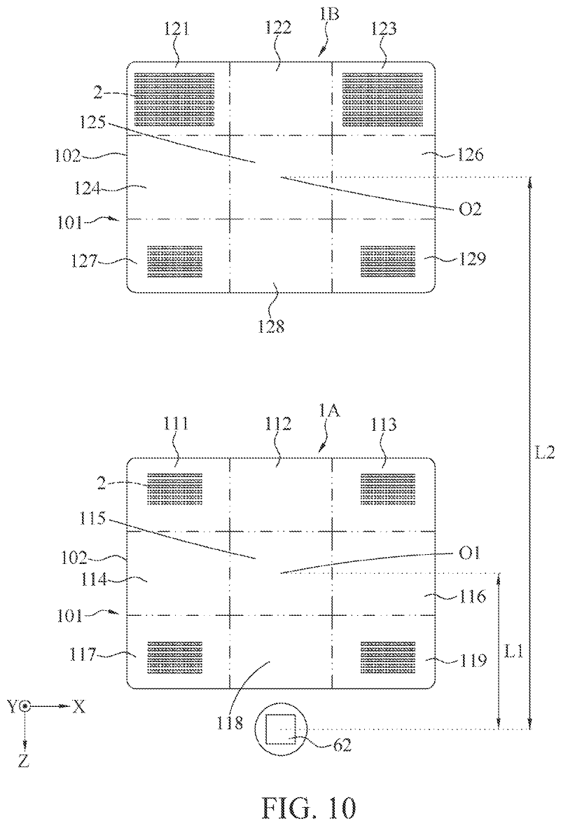

Referring to FIG. 1, FIG. 2 and FIG. 3 at the same time, according to some embodiments, for a backlight module 200 adapted to an illuminated keyboard 100. The backlight module 200 includes an illuminated component 62, a circuit board 66 and a light guide plate 7. The illuminated component 62 is disposed on the circuit board 66. The light guide plate 7 is disposed above the circuit board 66. The light guide plate 7 includes a plurality of single-key light guide regions 1 (a first single-key light guide region 1A and a second single-key light guide region 1B (as shown in FIG. 10) are taken as an example for description below, and the first single-key light guide region 1A and the second single-key light guide region 1B respectively define nine regions). In some embodiments, the first single-key light guide region 1A and the second single-key light guide region 1B are arranged in a straight direction (not limited to this), and may also be arranged in any direction. For example, two single-key light guide regions 1 in a key group region 52 as shown in FIG. 1 are arranged in a horizontal direction.

Referring to FIG. 10, the first single-key light guide region 1A corresponds to a first key 101, and the first single-key light guide region 1A defines nine regions. The second single-key light guide region 1B corresponds to a second key 101, and the second single-key light guide region 1B defines nine regions. The first single-key light guide region 1A includes a first first-sub-light guide region 111, a first third-sub-light guide region 113, a first seventh-sub-light guide region 117 and a first ninth-sub-light guide region 119 located in four diagonal regions respectively, a first fifth-sub-light guide region 115 located in a middle region, and a first second-sub-light guide region 112, a first fourth-sub-light guide region 114, a first sixth-sub-light guide region 116 and a first eighth-sub-light guide region 118 adjacent to the first fifth-sub-light guide region 115 respectively. The second single-key light guide region 1B includes a second first-sub-light guide region 121, a second third-sub-light guide region 123, a second seventh-sub-light guide region 127 and a second ninth-sub-light guide region 129 located in four diagonal regions respectively, a second fifth-sub-light guide region 125 located in a middle region, and a second second-sub-light guide region 122, a second fourth-sub-light guide region 124, a second sixth-sub-light guide region 126 and a second eighth-sub-light guide region 128 adjacent to the second fifth-sub-light guide region 125 respectively.

The first first-sub-light guide region 111, the first third-sub-light guide region 113, the first seventh-sub-light guide region 117, the first ninth-sub-light guide region 119, the second first-sub-light guide region 121, the second third-sub-light guide region 123, the second seventh-sub-light guide region 127 and the second ninth-sub-light guide region 129 respectively have a first first-light-emitting total area, a first third-light-emitting total area, a first seventh-light-emitting total area, a first ninth-light-emitting total area, a second first-light-emitting total area, a second third-light-emitting total area, a second seventh-light-emitting total area and a second ninth-light-emitting total area obtained by totaling the light-emitting areas 2a of a plurality of microstructures 2 disposed in each of the sub-light guide regions.

The sum of the first first-light-emitting total area, the first third-light-emitting total area, the first seventh-light-emitting total area and the first ninth light-emitting total area is smaller than the area sum of the first first-sub-light guide region 111, the first third-sub-light guide region 113, the first seventh-sub-light guide region 117 and the first ninth-sub-light guide region 119. The sum of the second first-light-emitting total area, the second third-light-emitting total area, the second seventh-light-emitting total area and the second ninth-light-emitting total area is smaller than the area sum of the second first-sub-light guide region 121, the second third-sub-light guide region 123, the second seventh-sub-light guide region 127 and the second ninth-sub-light guide region 129.

Based on the above design, microstructures 2 are distributed in four diagonal regions, therefore, the light can be transmitted to other single-key light guide regions 1 through the first fifth-sub-light guide region 115, the first second-sub-light guide region 112, the first fourth-sub-light guide region 114, the first sixth-sub-light guide region 116, the first eighth-sub-light guide region 118, the second fifth-sub-light guide region 125, the second second-sub-light guide region 122, the second fourth-sub-light guide region 124, the second sixth-sub-light guide region 126 and the second eighth-sub-light guide region 128 with no microstructures 2 distributed and regions between single-key light guide regions 1, so as to solve the problem that the brightness of each of the keys 101 on the keyboard 100 is obviously uneven.

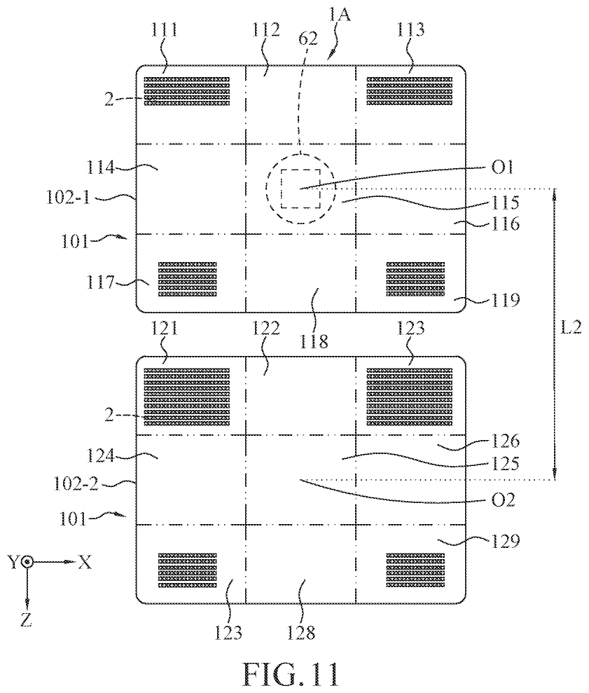

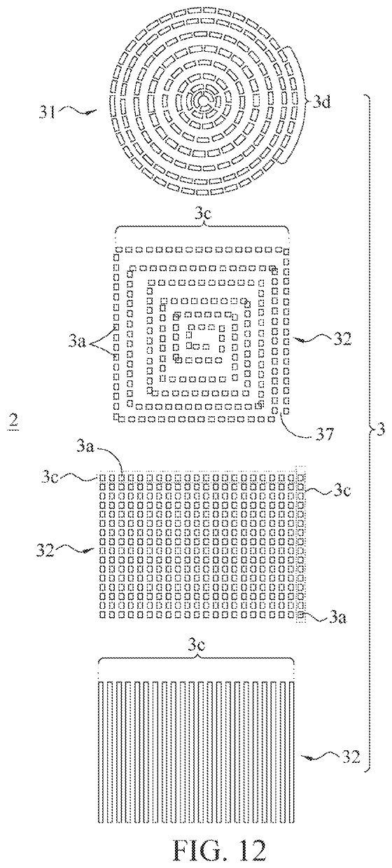

Referring to FIG. 1, FIG. 2, FIG. 10 and FIG. 11, FIG. 10 and FIG. 11 are schematic top views of a backlight module 200 corresponding to two key caps 102-1,102-2. In some embodiments, the first single-key light guide region 1A has a first center O1 corresponding to the center of a first key cap 102-1 above. The second single-key light guide region 1B has a second center O2 corresponding to the center of a second key cap 102-2 above. When a first distance L1 between the first center O1 and the center of the illuminated component 62 is smaller than a second distance L2 between the second center O2 and the center of the illuminated component 62, the first key cap 102-1 is close to the illuminated component 62, and the second key cap 102-2 is away from the illuminated component 62. Due to the light attenuation and the amount of available light, the light-emitting areas 2a of the microstructures 2 on the second key cap 102-2 need to be greater than the light-emitting areas 2a of the microstructures 2 on the first key cap 102-1, and then, the brightness of the second key cap 102-2 can be similar to the brightness of the first key cap 102-1. Therefore, by designing the sum of the first first-light-emitting total area, the first third-light-emitting total area, the first seventh-light-emitting total area and the first ninth-light-emitting total area to be smaller than the sum of the second first-light-emitting total area, the second third-light-emitting total area, the second seventh-light-emitting total area and the second ninth-light-emitting total area, the brightness of each of the keys 101 on the keyboard 100 is even.

In some embodiments, the illuminated component 62 may be disposed on the circuit board 66 at any position or angle. The center of the illuminated component 62 is not located at the position of the first center O1 (as shown in FIG. 10). There is a first distance L1 between the first center O1 and the center of the illuminated component 62. The first distance L1 is greater than 0 mm (not limited to this). In some embodiments, the center of the illuminated component 62 is located at the position of the first center O1 (as shown in FIG. 11). There is a first distance L1 between the first center O1 and the center of the illuminated component 62. The first distance L1 is equal to 0 mm.

In some embodiments, the area of a long-multiple key (as shown in FIG. 6) is greater than the area of a one-multiple key (as shown in FIG. 4). Especially, when the area of the long-multiple key is greater than twice the area of the one-multiple key, the light-emitting areas 2a of the microstructures 2 in the single-key light guide region 1 corresponding to the long-multiple key need to be greater than the light-emitting areas 2a of the microstructures 2 in the single-key light guide region 1 corresponding to the one-multiple key, so that the brightness of the long-multiple key can be similar to the brightness of the one-multiple key, and the brightness of each of the keys 101 on the keyboard 100 is even. Therefore, microstructures 2 are distributed in the second sub-light guide region 12, the fourth sub-light guide region 14, the sixth sub-light guide region 16 and the eighth sub-light guide region 18 on the single-key light guide region 1 corresponding to the long-multiple key so as to increase the light-emitting brightness of the long-multiple key, and this is one of the methods for solving the problem of uneven brightness of the long-multiple key and the one-multiple key. In some embodiments, when the area of the first single-key light guide region 1A is smaller than twice the area of the second single-key light guide region 1B (not shown in the figures, for example, as shown in FIG. 10, the area of the first single-key light guide region 1A is reduced or the area of the second single-key light guide region 1B is enlarged), the sum of the light-emitting areas 2a of a plurality of microstructures 2 in the first second-sub-light guide region 112, the first fourth-sub-light guide region 114, the first sixth-sub-light guide region 116 and the first eighth-sub-light guide region 118 is smaller than the sum of the light-emitting areas 2a of a plurality of microstructures 2 in the second second-sub-light guide region 122, the second fourth-sub-light guide region 124, the second sixth-sub-light guide region 126 and the second eighth-sub-light guide region 128. In some embodiments, when the first single-key light guide region 1A is a one-multiple key and the second single-key light guide region 1B is a long-multiple key, the sum of the light-emitting areas 2a of a plurality of microstructures 2 in the first second-sub-light guide region 112, the first fourth-sub-light guide region 114, the first sixth-sub-light guide region 116 and the first eighth-sub-light guide region 118 on the one-multiple key is smaller than the sum of the light-emitting areas 2a of a plurality of microstructures 2 in the second second-sub-light guide region 122, the second fourth-sub-light guide region 124, the second sixth-sub-light guide region 126 and the second eighth-sub-light guide region 128 on the long-multiple key.

Referring to FIG. 12 and FIG. 13, the figures are schematic views of combination of a plurality of different types of microstructures 2. In some embodiments, a single-key light guide region 1 has a light guide optical pattern 3. The light guide optical pattern 3 includes linear segments 3c, curve segments 3b, arc segments 3d or a combination thereof. Wherein the light-emitting area of the light guide optical pattern 3 is smaller than the area of the single-key light guide region 1. As shown in FIG. 12, a circle 31 at the uppermost position may be formed by arrangement of concentric circles with different diameters formed by arc segments 3d. A square 32 may be a spiral pattern surrounded by a plurality of dots 3a, and an opening 37 is formed at the end of the peripheral line of the spiral pattern; or the square 32 may be formed by equidistant or non-equidistant arrangement of a plurality of dots 3a; or the square 32 may be formed by equidistant or non-equidistant arrangement of linear segments 3c. The light guide optical pattern 3 may be formed by a plurality of dots 3a and a plurality of curve segments 3b or arc segments 3d, and a plurality of curve segments 3b or arc segments 3d may form one or a plurality of straight lines, curves, arcs, chain lines, etc. In some embodiments, a plurality of horizontal dots 3a or a plurality of vertical dots 3a in a square 32 or an arrow 33 form a linear segment 3c. In some embodiments, as shown in FIG. 13, a plurality of microstructures 2 have a light guide optical pattern 3 formed by one and combination of curve segments 3b, linear segments 3c and arc segments 3d. The light guide optical pattern 3 may be in the shape of an arrow 33 (formed by dots 3a), a wave 34, a curve 35, a square wave 36 and an arrow 33 (formed by linear segments 3c) as shown in FIG. 13 arranged from top to bottom, and the light guide optical pattern 3 may also be in a circle or other specific shapes. Through the combination of the above-mentioned microstructures 2, the light collection and light emission of the region area can be more effectively increased, thereby improving the light utilization efficiency of the illuminated component 62, the light-emitting brightness of the illuminated keyboard 100 and the even light effect of the keys 101.

In some embodiments, in order to get light sources for all keys 101 by disposing a small amount of illuminated components 62, the illumination angle of the used illuminated component 62 must not be too small. However, once the illumination angle is large, part of light sources cannot be used effectively, therefore, the scattered light needs to be effectively collected through the microstructures 2 and the combination change thereof. Referring to FIG. 1, FIG. 2 and FIG. 14, the figures are schematic views of the shape and arrangement of units of a plurality of microstructures 2. In some embodiments, the linear segments 3c, the curve segments 3b or the arc segments 3d have first microstructure unit 21, second microstructure unit 22 and third microstructure unit 23. The first microstructure unit 21 and the second microstructure unit 22 have different shapes, or the first microstructure unit 21 and the third microstructure unit 23 have different areas, or the second microstructure unit 22 and the third microstructure unit 23 are connected (meaning that the outer edges are in contact, as shown in FIG. 14, two circles at the lower right corner are tangentially connected) or overlapped (partially or fully overlapped), or there is a distance 20b between the first microstructure unit 21 and the third microstructure unit 23. Through the design of the different shapes of the first microstructure unit 21 and the second microstructure unit 22, light from different angles can be collected, and the light-emitting area 2a can be increased. Through the different areas of the first microstructure unit 21 and the third microstructure unit 23, the collected light can be increased or reduced, and the brightness can be finely adjusted in a manner of points to achieve the even light effect. The second microstructure unit 22 and the third microstructure unit 23 are connected or overlapped to intercept and collect a large amount of light, thereby fully utilizing the light without wasting and increasing the brightness. There is a distance 20b between the first microstructure unit 21 and the third microstructure unit 23, so that the light can be collected and emitted by the microstructures 2 at the rear of the traveling direction, so as to solve the uneven brightness problem that front blocks in the traveling direction of the light are bright but rear blocks are dark. Through the above design of the combination of the microstructures 2, the overall brightness can be increased without increasing the number of illuminated components 62, and the problem of uneven brightness can be effectively solved.

Furthermore, in addition to designing individual microstructures 2 to increase the efficiency of light collection, the combination of the microstructures 2 also improves the brightness of the illuminated keyboard 100 and the light homogenizing mode of the keys 101.

According to some embodiments, the light guide plate and the backlight module of the illuminated keyboard have the following advantages: 1. The distribution area of microstructure unit on the light guide plate is reduced. Excessive number and range of microstructure unit not only easily cause the problem of light leakage, but also increase the complexity of design and production. 2. There is no need to calculate the relative relationship between the arrangement density of the microstructures and the distance from an incident angle. 3. Different characters of keys in different countries are applicable, the ideal character brightness can be achieved without the need for individual design of the keys, and the manufacturing is relatively simple. 4. The microstructures are distributed from point, line to plane, and the microstructures are partially or fully disposed on the light guide plate corresponding to the key position. 5. According to the distance between the key and the illuminated component, the light-emitting areas of the microstructures can be systematically increased or reduced, and the microstructures can achieve the effect of even light for each of the keys through the combination of concentration, dispersion or sparse and dense mixing.

In conclusion, according to some embodiments, through the control of the light-emitting areas of a plurality of microstructures in the single-key light guide region of the light guide plate, the sum of the light-emitting areas of a plurality of microstructures in the four diagonal regions is smaller than the area sum of the four diagonal regions, and after a plurality of microstructures of each of the keys guide the light, the brightness of each of the keys is even for a user to view, thereby avoiding the condition that the brightness of each of the keys is obviously uneven.

What is claimed is:

1. A light guide plate of an illuminated keyboard, comprising:
a single-key light guide region, comprising a first sub-light guide region, a third sub-light guide region, a seventh sub-light guide region and a ninth sub-light guide region located in four diagonal regions respectively, a fifth sub-light guide region located in a middle region, and a second sub-light guide region, a fourth sub-light guide region, a sixth sub-light guide region and an eighth sub-light guide region adjacent to the fifth sub-light guide region respectively, wherein the sum of the light-emitting areas of a plurality of microstructures disposed in the first sub-light guide region is a first light-emitting total area, the sum of the light-emitting areas of a plurality of microstructures disposed in the third sub-light guide region is a third light-emitting total area, the sum of the light-emitting areas of a plurality of microstructures disposed in the seventh sub-light guide region is a seventh light-emitting total area, and the sum of the light-emitting areas of a plurality of microstructures disposed in the ninth sub-light guide region is a ninth light-emitting total area; and
the area sum of the first light-emitting total area, the third light-emitting total area, the seventh light-emitting total area and the ninth light-emitting total area is smaller than the area sum of the first sub-light guide region, the third sub-light guide region, the seventh sub-light guide region and the ninth sub-light guide region.

2. The light guide plate of the illuminated keyboard according to claim 1, wherein the sum of the light-emitting areas of a plurality of microstructures disposed in the fifth sub-light guide region is a fifth light-emitting total area, and the first light-emitting total area, the third light-emitting total area, the seventh light-emitting total area or the ninth light-emitting total area is greater than the fifth light-emitting total area.

3. The light guide plate of the illuminated keyboard according to claim 1, wherein the sum of the light-emitting areas of a plurality of microstructures disposed in the second sub-light guide region is a second light-emitting total area, the sum of the light-emitting areas of a plurality of microstructures disposed in the fourth sub-light guide region is a fourth light-emitting total area, the sum of the light-emitting areas of a plurality of microstructures disposed in the sixth sub-light guide region is a sixth light-emitting total area, the sum of the light-emitting areas of a plurality of microstructures disposed in the eighth sub-light guide region is an eighth light-emitting total area, and the area sum of the second light-emitting total area, the fourth light-emitting total area, the sixth light-emitting total area and the eighth light-emitting total area is smaller than the area sum of the first light-emitting total area, the third light-emitting total area, the seventh light-emitting total area and the ninth light-emitting total area.

4. The light guide plate of the illuminated keyboard according to claim 3, wherein the area sum of the first light-emitting total area, the second light-emitting total area and the third light-emitting total area is greater than the area sum of the first light-emitting total area, the fourth light-emitting total area and the seventh light-emitting total area.

5. The light guide plate of the illuminated keyboard according to claim 4, wherein the microstructures in the first sub-light guide region, the second sub-light guide region, the third sub-light guide region, the sixth sub-light guide region, the ninth sub-light guide region, the eighth sub-light guide region, the seventh sub-light guide region and the fourth sub-light guide region together form a loop shape.

6. A backlight module of an illuminated keyboard, comprising:
a circuit board;
an illuminated component located on the circuit board; and
a light guide plate disposed above the circuit board and comprising:
a first single-key light guide region, comprising a first first-sub-light guide region, a first third-sub-light guide region, a first seventh-sub-light guide region and a first ninth-sub-light guide region located in four diagonal regions respectively, a first fifth-sub-light guide region located in a middle region, and a first second-sub-light guide region, a first fourth-sub-light guide region, a first sixth-sub-light guide region and a first eighth-sub-light guide region adjacent to the first fifth-sub-light guide region respectively; and
a second single-key light guide region, comprising a second first-sub-light guide region, a second third-sub-light guide region, a second seventh-sub-light guide region and a second ninth-sub-light guide region located in four diagonal regions respectively, a second fifth-sub-light guide region located in a middle region, and a second second-sub-light guide region, a second fourth-sub-light guide region, a second sixth-sub-light guide region and a second eighth-sub-light guide region adjacent to the second fifth-sub-light guide region respectively, wherein the first first-sub-light guide region, the first third-sub-light guide region, the first seventh-sub-light guide region, the first ninth-sub-light guide region, the second first-sub-light guide region, the second third-sub-light guide region, the second seventh-sub-light guide region and the second ninth-sub-light guide region respectively have a first first-light-emitting total area, a first third-light-emitting total area, a first seventh-light-emitting total area, a first ninth-light-emitting total area, a second first-light-emitting total area, a second third-light-emitting total area, a second seventh-light-emitting total area and a second ninth-light-emitting total area obtained by totaling the light-emitting areas of a plurality of microstructures disposed in each of the sub-light guide regions; and
the area sum of the first first-light-emitting total area, the first third-light-emitting total area, the first seventh-light-emitting total area and the first ninth-light-emitting total area is smaller than the area sum of the first first-sub-light guide region, the first third-sub-light guide region, the first seventh-sub-light guide region and the first ninth-sub-light guide region, and the area sum of the second first-light-emitting total area, the second third-light-emitting total area, the second seventh-light-emitting total area and the second ninth-light-emitting total area is smaller than the area sum of the second first-sub-light guide region, the second third-sub-light guide region, the second seventh-sub-light guide region and the second ninth-sub-light guide region.

7. The backlight module of the illuminated keyboard according to claim 6, wherein the first single-key light guide region has a first center corresponding to the center of a first key cap above, the second single-key light guide region has a second center corresponding to the center of a second key cap above, and when a first distance between the first center and the center of the illuminated component is smaller than a second distance between the second center and the center of the illuminated component, the area sum of the first first-light-emitting total area, the first third-light-emitting total area, the first seventh-light-emitting total area and the first ninth-light-emitting total area is smaller than the area sum of the second first-light-emitting total area, the second third-light-emitting total area, the second seventh-light-emitting total area and the second ninth-light-emitting total area.

8. The backlight module of the illuminated keyboard according to claim 6, wherein when the area of the first single-key light guide region is smaller than twice the area of the second single-key light guide region, the sum of the light-emitting areas of the microstructures in the first second-sub-light guide region, the first fourth-sub-light guide region, the first sixth-sub-light guide region and the first eighth-sub-light guide region is smaller than the sum of the light-emitting areas of the microstructures in the second second-sub-light guide region, the second fourth-sub-light guide region, the second sixth-sub-light guide region and the second eighth-sub-light guide region.

9. A light guide plate of an illuminated keyboard, comprising:
a single-key light guide region, has a light guide optical pattern comprising a linear segment, a curve segment, an arc segment or a combination thereof, wherein the light-emitting area of the light guide optical pattern is smaller than the area of the single-key light guide region.

10. The light guide plate of the illuminated keyboard according to claim 9, wherein the linear segment, the curve segment or the arc segment has a first microstructure unit, a second microstructure unit and a third microstructure unit, the first microstructure unit and the second microstructure unit have different shapes, or the first microstructure unit and the third microstructure unit have different areas, or the second microstructure unit and the third microstructure unit are connected or overlapped, or there is a distance between the first microstructure unit and the third microstructure unit.
